(19) United States
(12) Patent Application Publication
(10) Pub. No.: US 2025/0196030 A1
(43) Pub. Date: Jun. 19, 2025

(54) Y-STRAINER

(71) Applicant: Dynamic Fabrication, Inc., Phoenix, AZ (US)

(72) Inventor: Cameron Karber, Paradise Valley, AZ (US)

(21) Appl. No.: 18/988,218

(22) Filed: Dec. 19, 2024

Related U.S. Application Data
(60) Provisional application No. 63/612,317, filed on Dec. 19, 2023.

(51) Int. Cl. B01D 35/02; B01D 29/11; B01D 35/30; E03B 7/07

(52) U.S. Cl. CPC B01D 35/02; B01D 29/11; B01D 35/30; E03B 7/074; B01D 2201/301

(57) ABSTRACT

A piping system includes a y-strainer comprising a main conduit defining an inlet at a first end of the main conduit and an outlet at a second end of the main conduit opposite the first end; a bonnet extending at an angle from the main conduit, the bonnet defining a distal end from the main conduit; and a strainer element positioned within the bonnet; and insulation wrapped around the main conduit of the y-strainer, the distal end of the bonnet positioned entirely exterior to the insulation.

### REFERENCE TO RELATED APPLICATIONS

This application claims the benefit of U.S. Provisional Application No. 63/612,317, filed Dec. 19, 2023, which is hereby specifically incorporated by reference herein in its entirety.

### TECHNICAL FIELD

This disclosure relates to y-strainers. In particular, this disclosure relates to a y-strainer with a lengthened or elongated bonnet.

### BACKGROUND

Y-strainers are often used in the field of commercial plumbing to help filter out unwanted particles from a fluid flowing through a series of pipes. Unfortunately, when y-strainers are covered in insulation to prevent temperature change in the fluids, performing some maintenance tasks on the y-strainers can become burdensome, often requiring removal of portions or all of the insulation wrapped around the y-strainer. Placing the insulation back around the y-strainer after maintenance of the y-strainer can also prove difficult, and in some cases the removal of the insulation can damage the insulation, requiring new insulation to be installed around the y-strainer.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

This paper describes various embodiments that relate to a y-strainer.

Disclosed is a piping system comprising a y-strainer comprising a main conduit defining an inlet at a first end of the main conduit and an outlet at a second end of the main conduit opposite the first end; a bonnet extending at an angle from the main conduit, the bonnet defining a distal end from the main conduit; and a strainer element positioned within the bonnet; and insulation wrapped around the main conduit of the y-strainer, the distal end of the bonnet positioned entirely exterior to the insulation.

Also disclosed is a y-strainer comprising a main conduit defining an inlet at a first end of the main conduit and an outlet at a second end of the main conduit opposite the first end; a bonnet extending at an angle from the main conduit, the bonnet defining a distal end from the main conduit and comprising a base and an extension piece the base extending from the main conduit and the extension piece attached to the base and extending to the distal end of the bonnet; and a strainer element positioned within the bonnet.

Also disclosed is a method of installing a piping system, the method comprising positioning a y-strainer between a first pipe and a second pipe, the y-strainer comprising a main conduit, a bonnet extending at an angle from the main conduit to a distal end from the main conduit, and a strainer element positioned in the bonnet; and wrapping insulation around the main conduit, wherein the distal end of the bonnet is entirely exterior to the insulation.

Other aspects and advantages of the described embodiments will become apparent from the following detailed description taken in conjunction with the accompanying drawings which illustrate, by way of example, the principles of the described embodiments.

### BRIEF DESCRIPTION OF THE FIGURES

The disclosure will be readily understood by the following detailed description in conjunction with the accompanying drawings, wherein like reference numerals designate like structural elements, and in which:

FIG. 1A shows an insulated y-strainer installed between two pipes according to one aspect of the current disclosure.

FIG. 1B shows a cross-sectional side view of the y-strainer depicted in FIG. 1A.

FIG. 2A shows an insulated y-strainer with an elongated bonnet installed between two pipes, according to another aspect of the current disclosure.

FIG. 2B shows a cross-sectional side view of the insulated y-strainer depicted in FIG. 2A.

FIG. 2C shows a cross-sectional side view of the insulated y-strainer depicted in FIG. 2A, according to another aspect of the current disclosure.

FIG. 3A shows a y-strainer comprising an elongated bonnet installed between two pipes, according to another aspect of the current disclosure.

FIG. 3B shows a cross-sectional side view of the insulated y-strainer depicted in FIG. 3A.

### DETAILED DESCRIPTION

The described embodiments relate to a y-strainer with an elongated bonnet that can reduce the amount of labor needed to perform maintenance on the y-strainer.

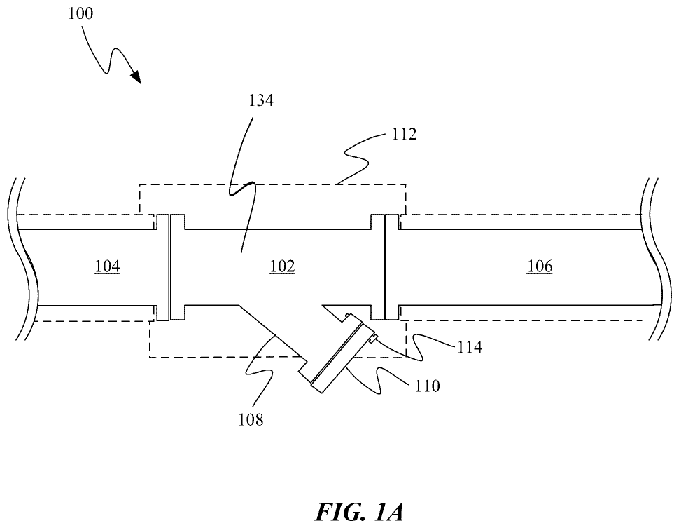

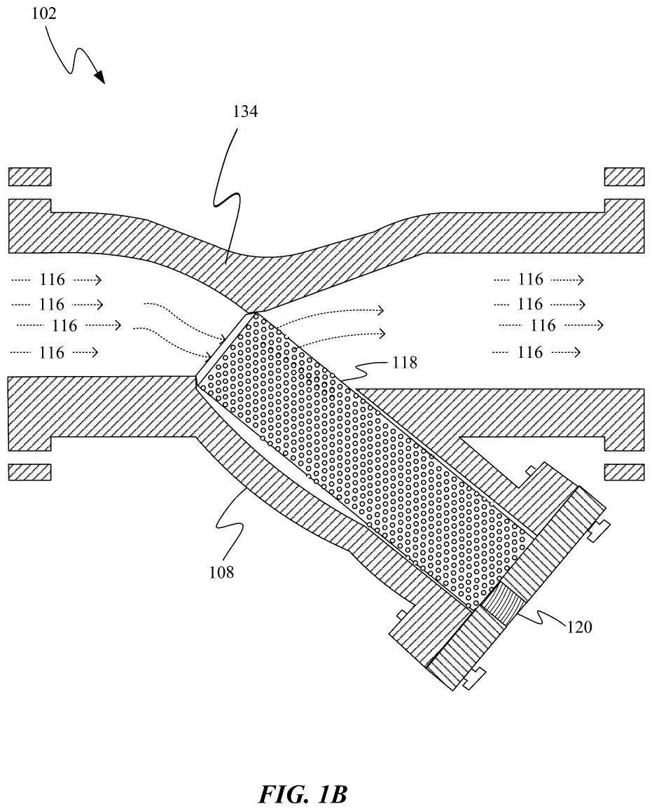

FIG. 1A shows a side view of a piping system 100 that includes exemplary y-strainer 102 positioned between a first pipe 104 and a second pipe 106. Y-strainer 102 can comprise a bonnet 108 that branches off and generally downwards from y-strainer 102. The bonnet 108 can extend at an angle from the main conduit 134. In some aspects, the angle can be between zero and 90 degrees. In some aspects, the angle can be about 45 degrees. Bonnet 108 can accommodate insertion and positioning of a strainer element 118 (shown in FIG. 1B) within y-strainer 102 such that any water passing through y-strainer 102 can be filtered by the strainer element 118. The strainer element 118 can generally take the form of a cylindrical mesh or perforated screen. A rear end of bonnet 108 can be closed off by a cap 110 secured to a distal end of bonnet 108, which can be a flanged connection in some aspects. Cap 110 can be generally responsible for keeping the strainer element 118 in place within the y-strainer 102 during operation of y-strainer 102. In some embodiments, cap 110 can include a blowdown port 120 (shown in FIG. 1B) taking the form of a small opening that can be used to clean the strainer element 118 without removal of cap 110.

FIG. 1A also shows dotted lines indicating where insulation 112 would be installed when piping system 100 is being used to carry heated or chilled water. Insulation 112 can help to keep piping system 100 running as efficiently as possible by reducing the temperature change in fluids flowing through piping system 100. FIG. 1 also shows how the insulation 112 covers a majority of bonnet 108 and even a portion of cap 110 that includes one or more fasteners 114 configured to secure cap 110 to bonnet 108. While covering y-strainer 102 in this manner is helpful for preventing undesirable heat transfer, any maintainer, such as a custodian or maintenance staff member or a contractor such as a plumber, trying to remove cap 110 to access the strainer element 118 would be unable to remove cap 110 without disturbing and possibly damaging the insulation 112 surrounding it. For this reason, maintenance on insulated y-strainers 102 is often time consuming and costly as in most cases the insulation 112 surrounding the main conduit 134 of y-strainer 102 needs replacing if torn or otherwise deformed during a maintenance action.

FIG. 1B shows a cross-sectional side view of y-strainer 102. FIG. 1B illustrates how fluid 116 travels from a left side (relative to the view of FIG. 1B) or inlet of the main conduit 134 of y-strainer 102 through the strainer element 118 and then continues to the right (relative to the view of FIG. 1B) and out at an outlet of the main conduit 134 of y-strainer 102. Strainer element 118 is depicted as a cylindrical filter with a distal end that can engage and seal against sidewalls of the main conduit 134 and bonnet 108 of y-strainer 102 to force any fluid flowing through y-strainer 102 to flow into strainer element 118 and through perforations in sidewalls of strainer element 118 before continuing on. The perforations in strainer element 118 are sized to prevent the passage of contaminants above a threshold size. In this way, the contaminates can be retained within strainer element 118 and prevented from continuing on and fouling up downstream components such as heat exchangers or the like.

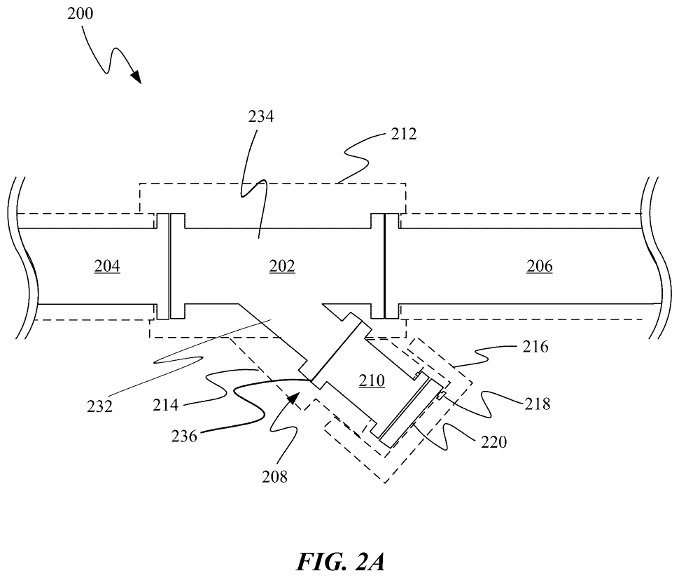

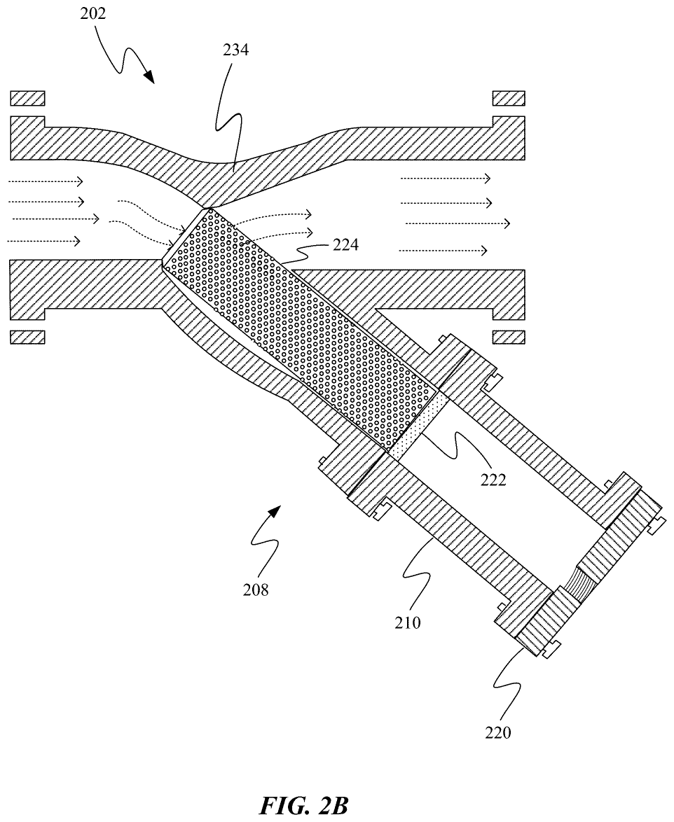

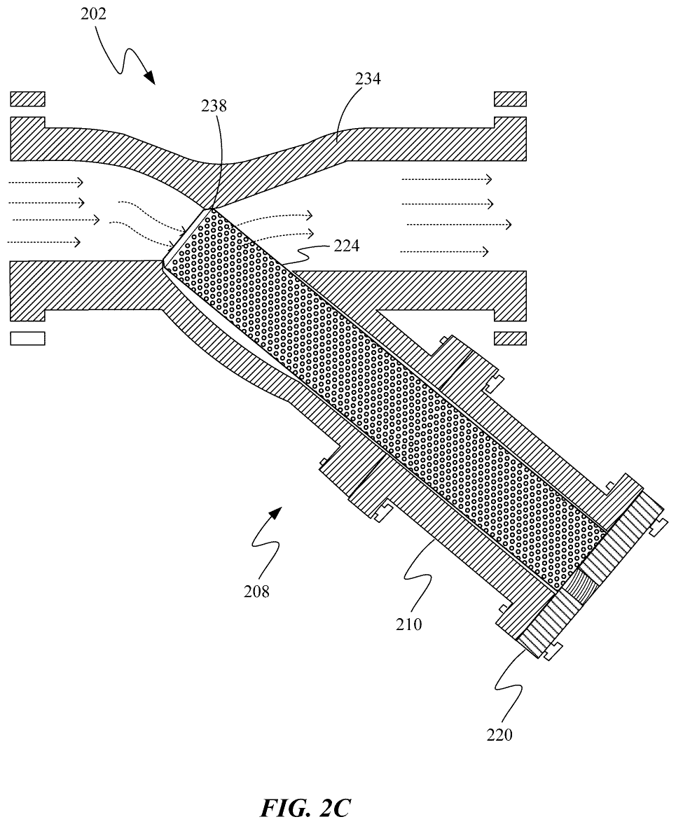

FIG. 2A shows a piping system 200 in accordance with another aspect of the current disclosure. As with piping system 100, piping system 200 includes a y-strainer 202 positioned between a first pipe 204 and a second pipe 206. Y-strainer 202 can comprise a main conduit 234 and a bonnet 208 that branches off and generally downwards from the main conduit 234. The bonnet 208 can accommodate insertion and positioning of a strainer element 224 (shown in FIG. 2B) within y-strainer 202 such that any water passing through y-strainer 202 is filtered by the strainer element 224. In this embodiment, bonnet 208 is elongated using an extension piece 210. In the current aspect, the bonnet 208 with the extension piece 210 can extend past the outlet of the main conduit 234 in a direction parallel to a longitudinal direction defined by the main conduit 234. In the current aspect, the extension piece 210 can be a pipe section defining flanged ends. The bonnet 208 can thereby comprise a base 232 and the extension piece 210. The base 232 can extend from the main conduit 234 of the y-strainer 202 and attach to the extension piece 210 with a flanged connection 236. Extension piece 210 allows a distal end of bonnet 208, including a cap 220, to extend past a portion of insulation 212 that wraps around the main conduit 234 of y-strainer 202. The cap 220 and the distal end of the bonnet 208 are thereby entirely exterior to the insulation 212 wrapped around the main conduit 234 of the y-strainer 202. This allows bonnet 208, including a portion of the base 232 and the extension piece 210, to be long enough to be wrapped in a second piece of insulation 214. In some aspects, an insulating cover 216 can be added to cover the distal end of bonnet 208, including cap 220. This configuration allows for simpler access to bonnet 208 since by removing insulating cover 216, a maintainer can remove one or more fasteners 218 securing cap 220 to extension piece 210 without disrupting or damaging insulation 212 or insulation 214.

FIG. 2B shows a cross-sectional side view of y-strainer 202. In particular, FIG. 2B shows details of extension piece 210 and how, in some aspects, the extension piece 210 can comprise a spacer element 222 that prevents strainer element 224 from disengaging from the sidewalls of the main conduit 234 and bonnet 208 of y-strainer 202. Spacer element 222 can extend across the opening of extension piece 210 to prevent movement of strainer element 224 into the channel defined by extension piece 210 and towards the distal end of the bonnet 208. In some embodiments, spacer element 222 can include two orthogonal cross members, while in other embodiments the geometry of spacer element 222 can be more complex including three or more cross-members. When strainer element 224 requires maintenance, a maintainer can remove spacer element 222 allowing strainer element 224 to be removed for maintenance and/or replacement. In some embodiments, spacer element 222 can be kept in place within extension piece 210 by an interference fit. In some embodiments, an interior of extension piece 210 can include one or more tabs or a circumferential shoulder that help prevent unintentional movement of spacer element 222 during normal operation of y-strainer 202. The extension piece 210 can allow for a retrofitting of a preexisting y-strainer 102 (shown in FIG. 1A) to turn the y-strainer 102 into the y-strainer 202 with the elongated bonnet 208. The inclusion of the spacer element 222 can also allow for the preexisting strainer element 118 (shown in FIG. 1B) to be used as the strainer element 218 of the elongated bonnet 208.

FIG. 2C shows another aspect of the y-strainer 202. As shown in FIG. 2C, the strainer element 224 can be elongated such that the strainer element 224 extends entirely through the extension piece 210 to contact the cap 220. The spacer element 222 (shown in FIG. 2B) is therefore not present in the aspect shown in FIG. 2C. An elongated strainer element 224 can also extend the time between a maintainer having to remove or replace the strainer element 224 or to clean out the strainer element 224, as the strainer element 224 can thereby define a larger interior space to hold contaminants. As shown, the strainer element 224 can contact a retention shoulder 238 within the main conduit 234 at a first end of the strainer element 224, and can contact the cap 220 at a second end distal from the first end of the strainer element 224. In some aspects, when retrofitting the y-strainer 102 with the extension piece 210 without a spacer element 222 (shown in FIG. 2B), the strainer element 118 (shown in FIG. 1B) can be removed and replaced with the strainer element 218 of FIG. 2C to turn the y-strainer 102 (shown in FIG. 1A) into the y-strainer 202 of FIG. 2C.

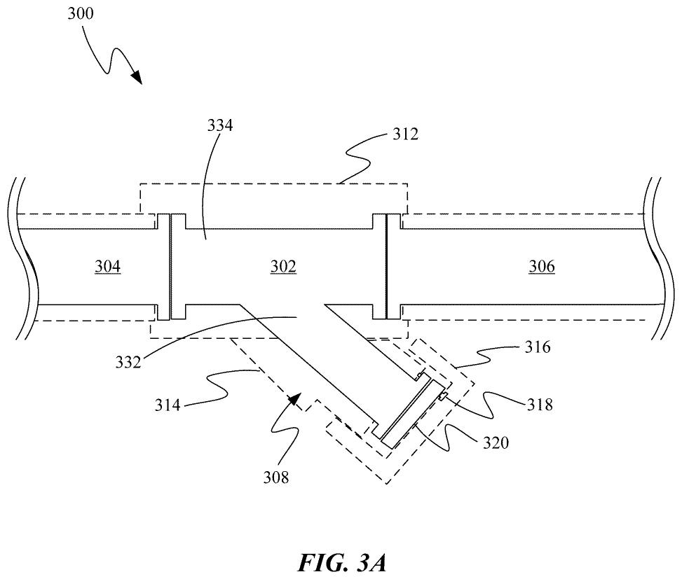

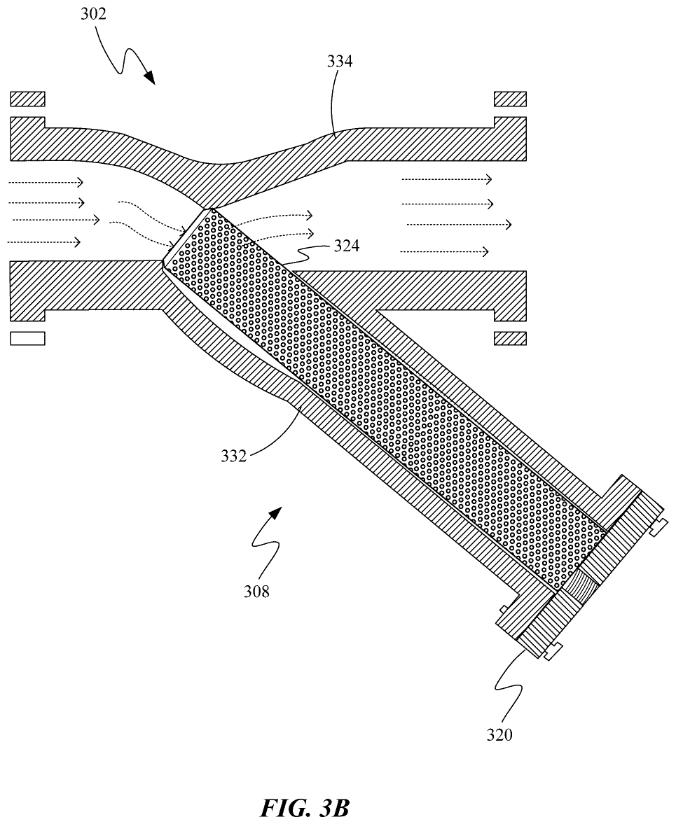

FIG. 3A shows a piping system 300 in accordance with another aspect of the current disclosure. As with piping systems 100 and 200, piping system 300 includes a y-strainer 302 positioned between a first pipe 304 and a second pipe 306. The y-strainer 302 can comprise a main conduit 334 and a bonnet 308 that branches off and generally downwards from the main conduit 334. The bonnet 308 can accommodate insertion and positioning of a strainer element 324 (shown in FIG. 3B) such that any water passing through y-strainer 302 is filtered by the strainer element 324.

As shown in FIG. 3A, the bonnet 308 is elongated similarly to bonnet 208 of FIG. 2A, such that, in the current aspect, the bonnet 308 can extend past the outlet of the main conduit 334 in a direction parallel to a longitudinal direction defined by the main conduit 334, but instead of an extension piece 210 (shown in FIG. 2A) providing elongation of the bonnet 208, an elongated base 332 of the bonnet 308 can extend past insulation 312 to cap 320. The elongated base 332 can be monolithic with the main conduit 334 all the way to attachment with the cap 320 with fasteners 318 and can be wrapped by a second piece of insulation 314. In some aspects, an insulating cover 316 can cover a distal end of bonnet 308, including cap 320, similar to insulating cover 216. The cap 320 and the distal end of the bonnet 308 are thereby entirely exterior to the insulation 312 wrapped around the main conduit 334 of the y-strainer 302.

FIG. 3B shows a cross-sectional side view of the y-strainer 302. In the current aspect, the strainer element 324 can be elongated similar to strainer element 224 of FIG. 2C such that the strainer element 324 can extend entirely through the elongated base 332 from the main conduit 334 to the cap 320. In other aspects, the strainer element 324 can be similar in size to the strainer element 224 of FIG. 2B and a spacer element similar to spacer element 222 can be mounted within the bonnet 308 to hold the strainer element 324 in place similar to as shown in FIG. 2B.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description can be monolithic whether or not such an explicit description of the structure is included herein.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A piping system, comprising:
a y-strainer comprising:
a main conduit defining an inlet at a first end of the main conduit and an outlet at a second end of the main conduit opposite the first end;
a bonnet extending at an angle from the main conduit, the bonnet defining a distal end from the main conduit; and
a strainer element positioned within the bonnet; and
insulation wrapped around the main conduit of the y-strainer, the distal end of the bonnet positioned entirely exterior to the insulation.

2. The piping system of claim 1, wherein a spacer element is disposed within the bonnet of the y-strainer and is offset from the distal end of the bonnet, wherein the spacer element prevents movement of the strainer element toward the distal end of the bonnet.

3. The piping system of claim 1, wherein the insulation is a first insulation, the piping system further comprising a second insulation wrapped around the bonnet of the y-strainer.

4. The piping system of claim 3, further comprising an insulating cover covering the distal end of the bonnet.

5. The piping system of claim 1, wherein the y-strainer further comprises a cap covering the distal end of the bonnet, the cap positioned entirely exterior to the insulation.

6. The piping system of claim 1, wherein the y-strainer extends from the main conduit to the distal end of the bonnet.

7. The piping system of claim 1, wherein the bonnet defines an elongated base that is monolithic from the distal end of the bonnet to the main conduit of the y-strainer.

8. The piping system of claim 1, wherein the bonnet comprises an extension piece and a base, the base extending from the main conduit and the extension piece attached to the base and extending to the distal end of the bonnet.

9. The piping system of claim 8, wherein the extension piece is attached to the base with a flanged connection.

10. A y-strainer comprising:
a main conduit defining an inlet at a first end of the main conduit and an outlet at a second end of the main conduit opposite the first end;
a bonnet extending at an angle from the main conduit, the bonnet defining a distal end from the main conduit and comprising a base and an extension piece the base extending from the main conduit and the extension piece attached to the base and extending to the distal end of the bonnet; and
a strainer element positioned within the bonnet.

11. The y-strainer of claim 10, wherein a spacer element is disposed within the bonnet of the y-strainer and is offset from the distal end of the bonnet, wherein the spacer element prevents movement of the strainer element toward the distal end of the bonnet.

12. The y-strainer of claim 11, wherein the spacer element prevents the strainer element from moving into the extension piece.

13. The y-strainer of claim 10, wherein the strainer element extends from the main conduit to the distal end of the bonnet.

14. The y-strainer of claim 10, further comprising a cap covering the distal end of the bonnet, wherein the strainer element extends from the main conduit to the cap.

15. The y-strainer of claim 10, wherein the bonnet extends past the outlet of the main conduit in a direction parallel to a longitudinal direction defined by the main conduit.

16. A method of installing a piping system, the method comprising:
positioning a y-strainer between a first pipe and a second pipe, the y-strainer comprising a main conduit, a bonnet extending at an angle from the main conduit to a distal end from the main conduit, and a strainer element positioned in the bonnet; and
wrapping insulation around the main conduit, wherein the distal end of the bonnet is entirely exterior to the insulation.

17. The method of claim 16, wherein the insulation is a first insulation, the method further comprising wrapping a second insulation around the bonnet.

18. The method of claim 16, further comprising covering the distal end of the bonnet with an insulating cover.

19. The method of claim 16, further comprising attaching an extension piece to a base of the bonnet to form an elongated bonnet.

20. The method of claim 19, wherein attaching the extension piece to the base of the bonnet comprises positioning a spacer element within the extension piece against the y-strainer.
